(19) United States
(12) Patent Application Publication
(10) Pub. No.: US 2016/0319713 A1
(43) Pub. Date: Nov. 3, 2016

(54) Electromagnet valve actuation with controller

(71) Applicant: Joseph Sook, Derby, KS (US)

(72) Inventor: Joseph Sook, Derby, KS (US)

(21) Appl. No.: 14/659,211

(22) Filed: Apr. 29, 2015

(51) Int. Cl. F01L 9/04; F02D 13/02; F02D 41/26

(52) U.S. Cl. CPC F01L 9/04; F02D 41/26; F02D 13/02; F01L 2009/0478; F01L 2009/0469; F01L 2009/0461

(57) ABSTRACT

This patent discloses Electromagnetic Valve Actuation and magnet controller. The valve movement is controlled by an upper and lower electromagnet opposite each other on the central vertical axis. The lower magnet rests in the valve spring seat allowing the valve to retain stock position in the cylinder head. The valve is threaded for a valve keeper that is placed between the upper and lower magnets. It changes the magnetic force into valve motion. The upper magnets are placed above the valve keepers with a valve cover of non-magnetic material that aligns and retains the upper magnets. The Top Dead Center Indicator (TDCI) is also disclosed. The TDCI is driven by the crankshaft to indicate when the engine has reached top dead center for cylinder #1. A magnet controller (Valve Control Module) is also disclosed. It is a Processor based controller that actuates Silicon rectifiers (SCR). The firmware to control is also disclosed. The firmware works with the trigger wheel on the engine to indicate the “Specific Count” number for valve operation. The firmware has “Valve Maps” for variable duration and lift or a specific single count number.

### CROSS-REFERENCE TO RELATED APPLICATIONS

### Background

The following is a list of prior patents that appear presently relevant:

### U.S. Patents

| Patent Number | Issue Date | Patentee | Country |
|---|---|---|---|
| 5,095,856 | Mar. 17, 1992 | Kawamura, Hideo | USA |
| 6,082,315 | Jul. 4, 2000 | Schneider, Leo | USA |

### Foreign Patent Documents

### WO/2000/014386 Mar. 16, 2000 Schneider, Leo WIPO

### Non-Patent Literature Documents

Boldea, Ion & Nasar, S. A., Linear Motion Electromagnetic Devices, Ann Arbor, Mich.: Sheridan Books. Print.
Then internal combustion engine has adapted to the demands of lower costs and increased efficiency, but has retained the camshaft. The camshaft is one of the oldest parts of the engine, but increased fuel efficiency, engine life, and less consumption of materials has become the industry standard. This new mantra is in direct conflict with the outdated camshaft. This invention opens the door to efficient cylinder head, combustion chamber, and reduced parasitic loss of the camshaft through the adoption of Electromagnets.

Controlling the valves in an engine is the function of the camshaft. The computer controls and electromagnets discussed in this patent take control of the engine intake and exhaust valves for the elimination of camshaft. Processor-based controllers adjust the amount of time valves are open or closed in relation to the crankshaft by energizing a pair of electromagnets. The electromagnets act upon threaded valve keepers to move the valves.

Currently cylinder heads are designed with camshaft placement in mind. Restrictions on number of valves, valve placement, combustion chamber design, intake and exhaust port design, and camshaft placement are factors that inhibit cylinder head design. After removal of the camshaft and all its drivetrain, the design of cylinder heads change allowing intake and exhaust ports to be tailored to engine's specification. The valve angles, valve placement, number of valves per cylinder, and combustion chamber design are unique to each design. This invention makes engines with four valves per cylinder common. After the adoption of this patent, aftermarket cylinder heads can be developed to give older engines a direct bolt on four valve hemi head to improve the engine's efficiency. Another advantage to the new cylinder head is the reduced valve length and diameter, reducing the weight of the valves. Conclusively this patent eliminates the restrictions placed on cylinder head design that work around the pushrods or cam drivetrain for the operations of the valves.

Patents have been proposed to use electromagnets to control valves, but these previous proposals have all had inherent problems. These problems include lack of controls for the magnets, specification of magnet materials, the designs are cumbersome or prohibitive to the engine shape, and require the need for exotic materials or machine work. The need for direct “drop-in” electromagnet assemblies that do not require reworking the cylinder head or using exotic materials is present. The greatest fault of all the prior patents is the lack of ability to control the valve. The computing power and firmware necessary to monitor the sensors is cumbersome, compounding the costs of development and implementation. Thus the prior patents concerning the actuation of engine valves suffer from a number of disadvantages:

(a) Require exotic materials valve construction.

(b) Require sensors for valve position detection

(c) Lack outlines for control of the engine valve

(d) Size prohibitive to the current engine shape

(e) Require new cylinder head designs

(f) Does not address removal of camshaft in the engine

(g) Does not address timing of valve operation

(h) Still use retention springs for closing engine valves

(i) Valve shape becomes larger and more cumbersome

### SUMMARY

A method of controlling the engines valves using electromagnets, threaded valve, keeper, and controller.

### ADVANTAGES

Accordingly several advantages of the invention: simple installation of magnets on the cylinder head, simple valve shape, retains current cylinder head configuration, minimal weight, adjustability of valve duration and depth, reduced parasitic loss, and reduced material consumption. Other advantages of one or more aspects will be apparent from consideration of the drawings and descriptions.

### DRAWINGS

### Figures

The drawings have a figure number and an alphabetical suffix. The alphabetical suffix is to distinguish views of the figure.

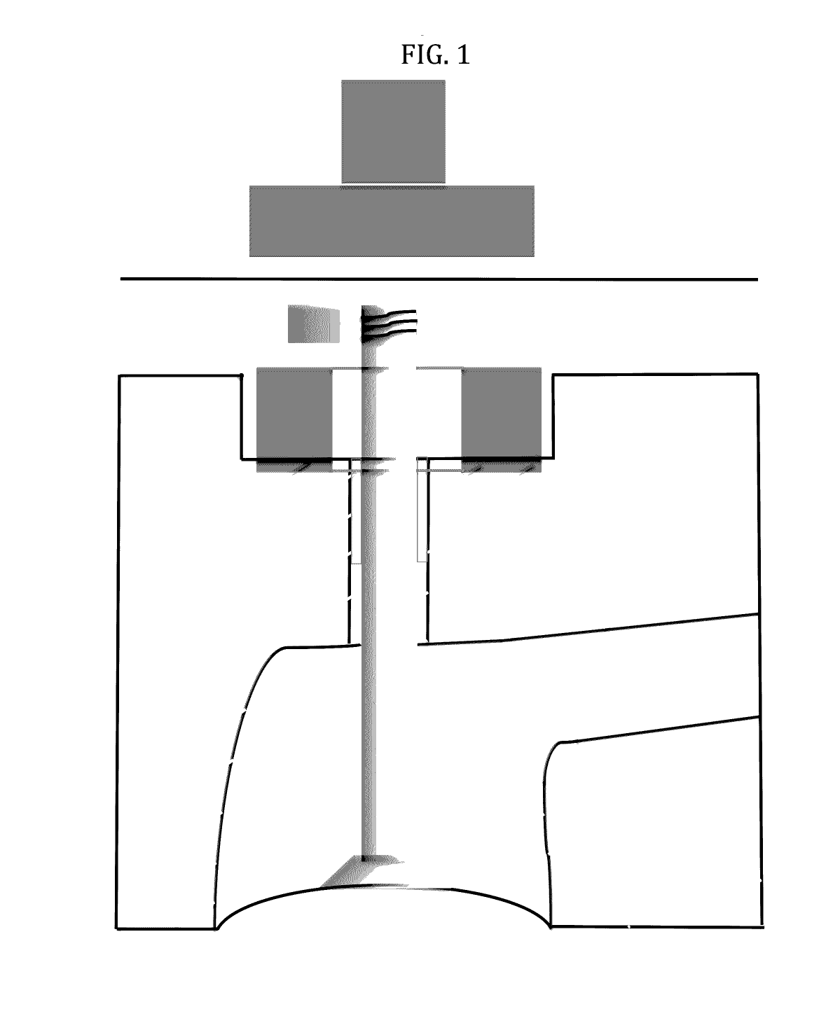

FIG. 1 is a cut away of the invention installed in a cylinder head. As shown in FIG. 1 the upper magnet is directly above the valve cover, threaded valve keeper, valve, and lower magnet.

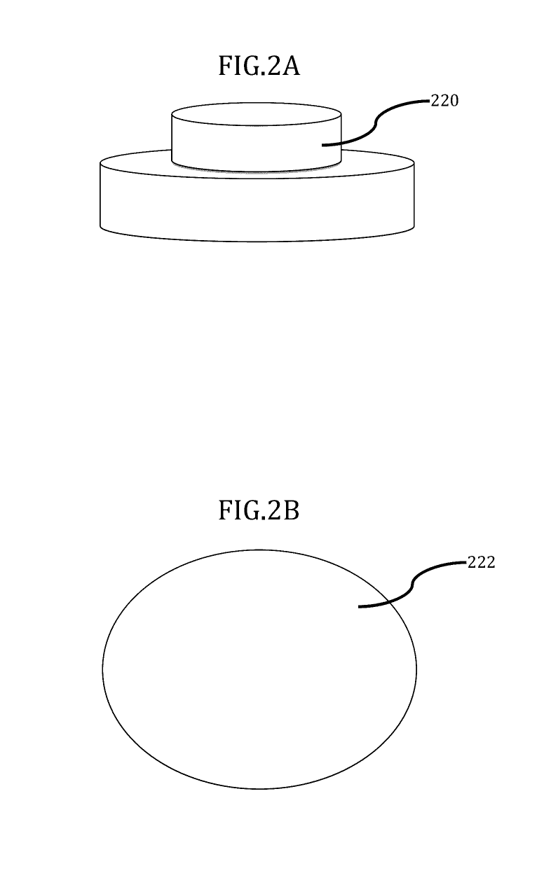

FIG. 2A/B is the Upper magnet. FIG. 2A is the side view of the upper magnet. FIG. 2A shows the upper spindle that in some applications will have an upper flange to retain the wrapped wire. FIG. 2B is the upper magnet lower face. This is the part that faces the threaded valve keeper at all times and what the magnet rests on in the valve cover.

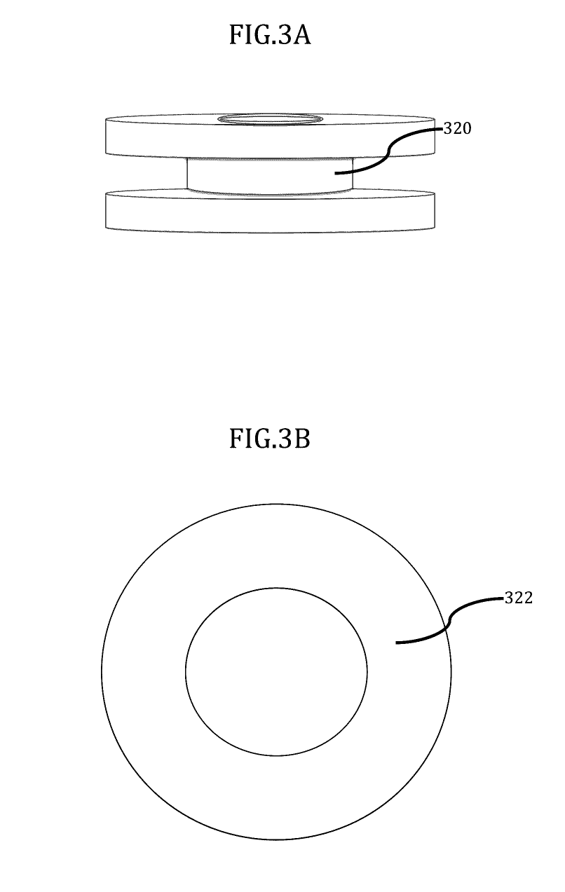

FIG. 3A/B is the Lower Magnet. It has 2 faces, an upper and lower face. The lower face is the diameter of the valve spring seat in the cylinder head and is precision machined to occupy the entire (with respect to the valve guide and boss) recession where the valve spring once was. FIG. 3A is the side view showing the center spindle, upper face, and lower face. FIG. 3B is the top view of the lower magnet. FIG. 3B shows the center bore of magnet.

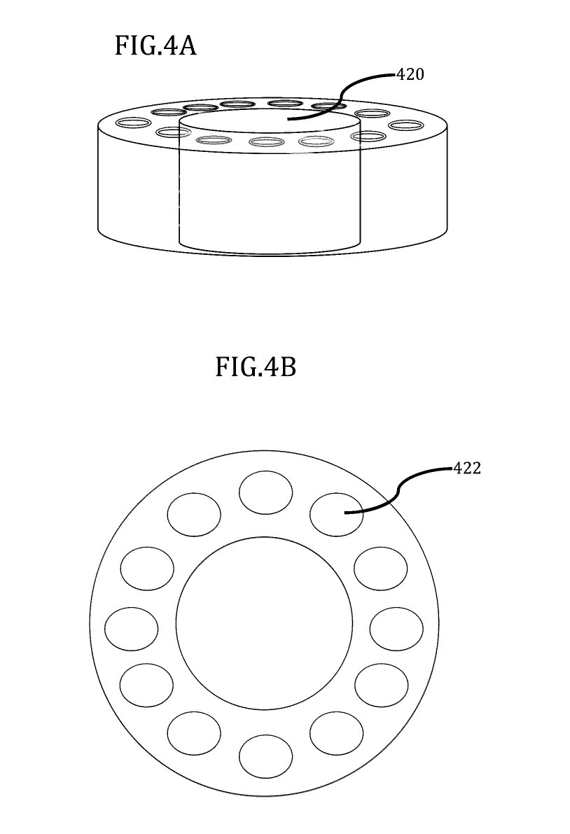

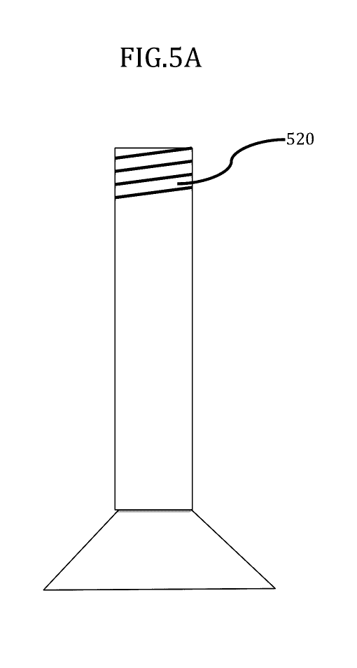

FIG. 4A/B is the Threaded Valve Keeper. It is constructed of materials that are lite-weight and react to magnet pull (Example: laminated iron). The outer diameter of the threaded valve keeper is the same outer diameter of the lower magnets upper face. The center bore is threaded to match the threading on the valve stem. FIG. 4A is the side view of the threaded valve keeper. FIG. 4B is the top view of the threaded keeper.

FIG. 5A is the Threaded Valve. The valve is threaded on the shank end to retain the threaded valve keeper to the valve.

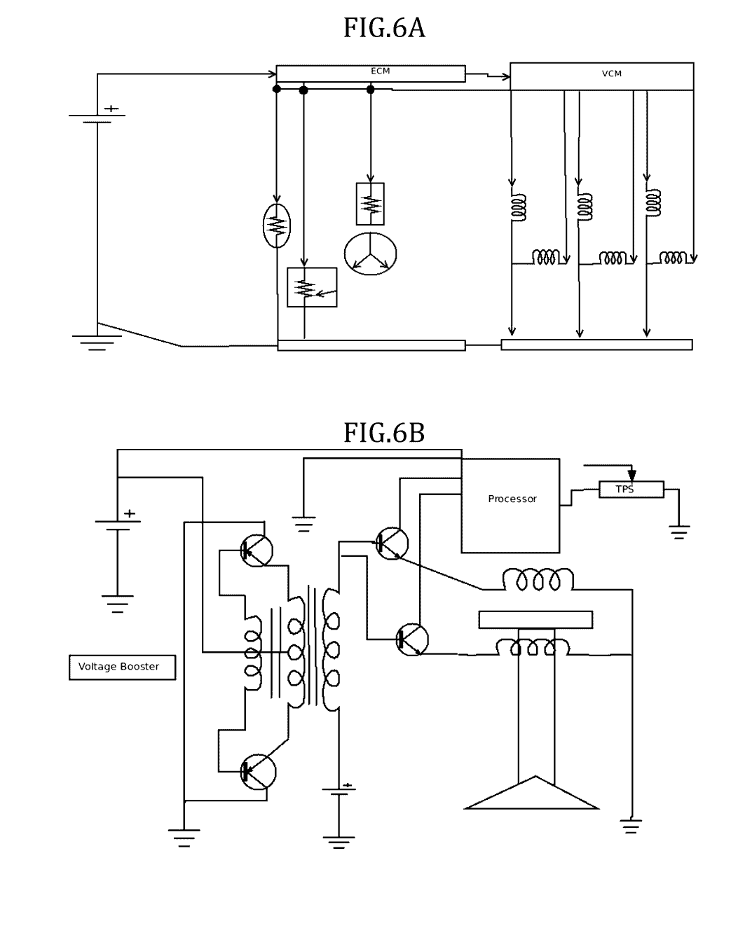

FIG. 6A. Is the General wiring schematic which overlays the Electronic Control Module (ECM) with the Valve Control Module (VCM) and input sensors for Patent the operation of the VCM. FIG. 6B is the General schematic about the VCM. Both these schematics are representative only.

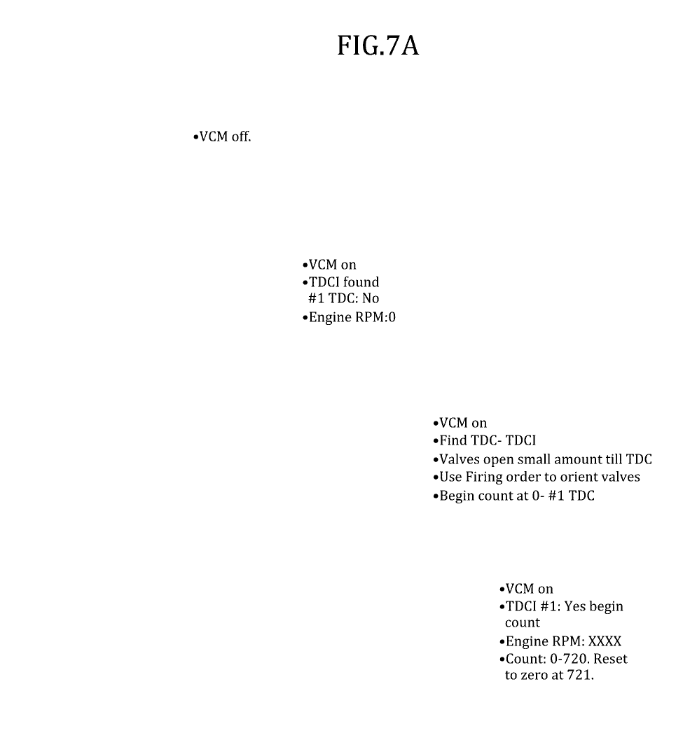

FIG. 7A is a software flowchart. It outlines how the VCM software functions.

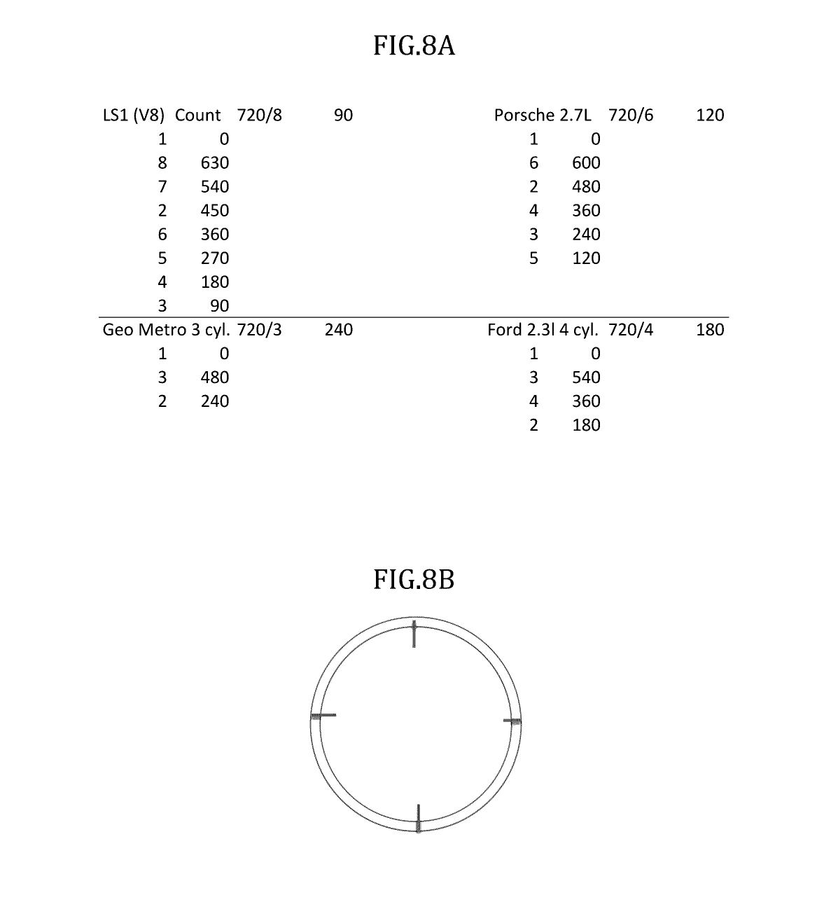

FIG. 8A is a few examples of the specific start count for example engines. These are programmed into the software as initial start counts for each cylinder. FIG. 8B is an example of the diagram to help develop the valve operation relative to piston movement in the four-stroke cycle.

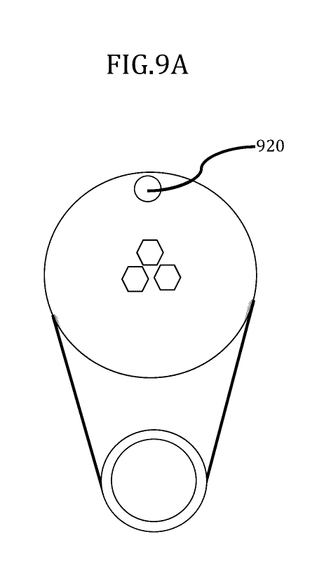

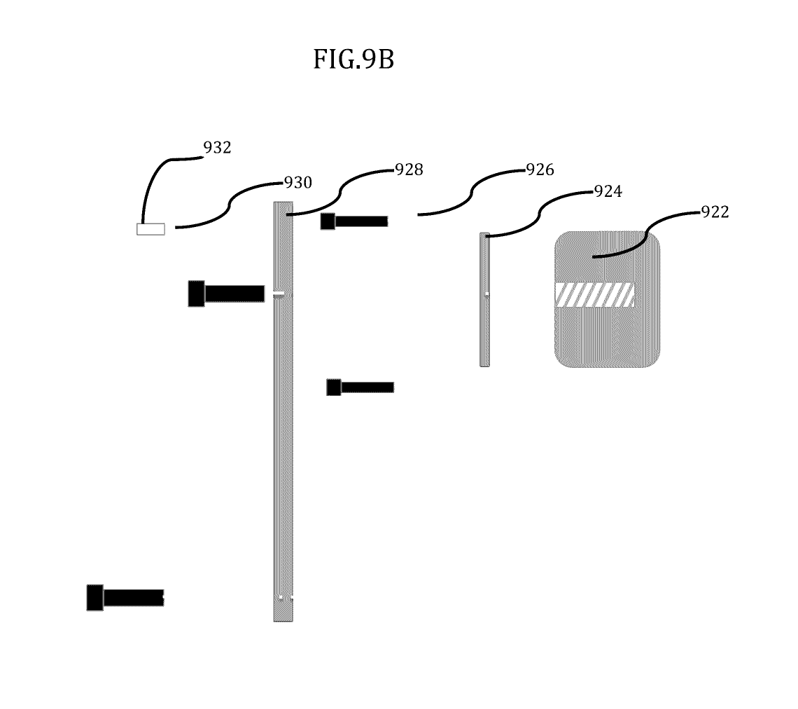

FIGS. 9A and 9B are examples of the Top Dead Center Indicator for a “cam in block” engine. FIG. 9B is the timing set assembly from the side.

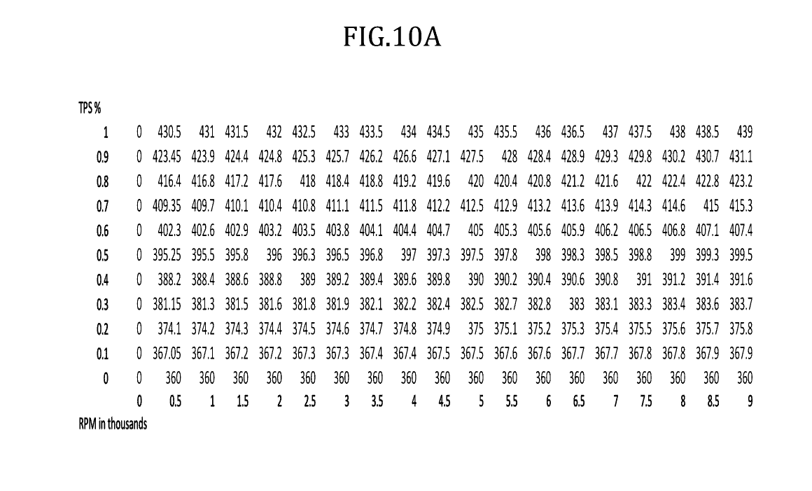

FIG. 10A is an example of the valve chart used to establish the specific count number to operate the exhaust valve and is 1 of 2 charts for the exhaust valve.

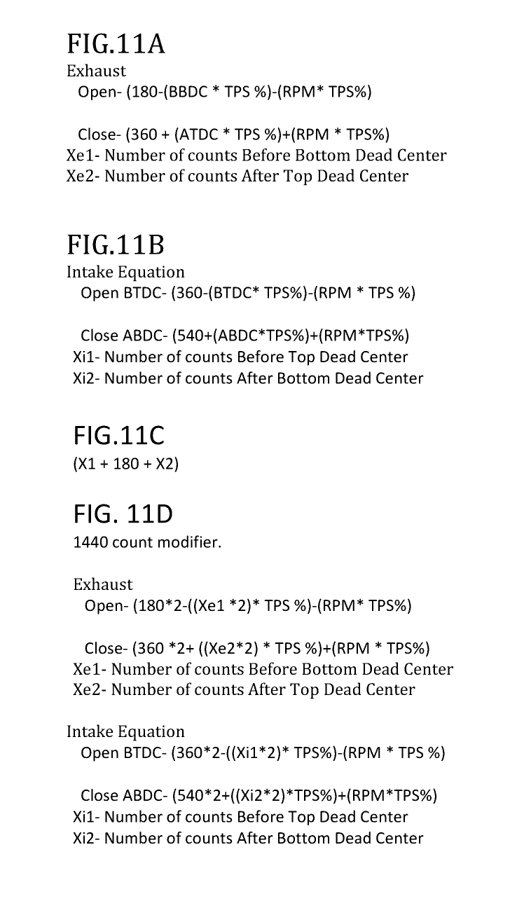

FIG. 11A is the modified equation for the 180-window (720 count) trigger wheel. It is the equation for variable duration of the Exhaust valve. FIG. 11B is modified equation for the 180-window (360) trigger wheel. It is the equation for variable duration of the Intake valve. FIG. 11C is equation to determine valve profile duration. FIG. 11D is the modified equation for variable timing with the 360-window (1440 count) trigger wheel.

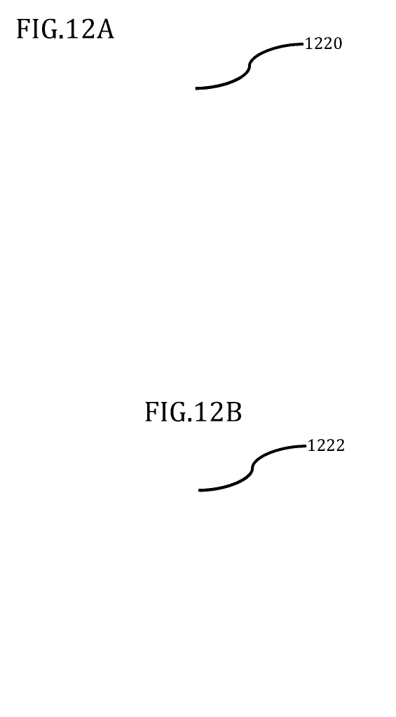

FIG. 12A is the trigger wheel with 180 windows for the 360 count. FIG. 12B is the trigger wheel with 360 windows for the 720 count. The windows go around the full circle in the pattern shown. There are only a few drawn into the picture to make them easier to identify.

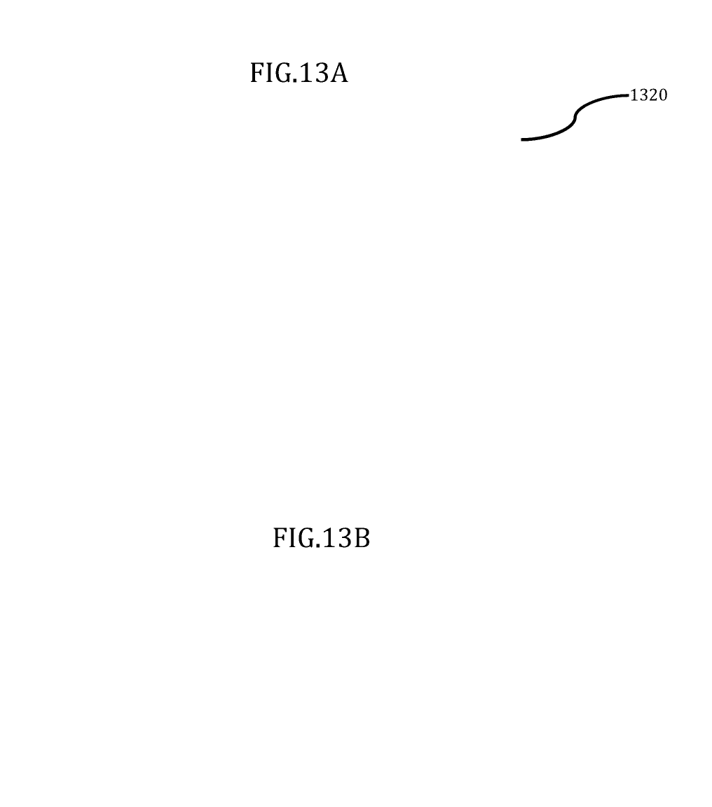

FIG. 13A is the Optic sensor and FIG. 13 B is the optic sensor mount.

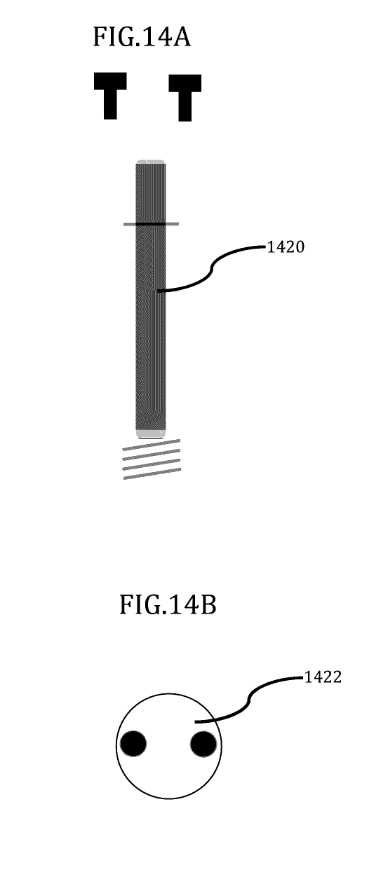

FIG. 14A is the “Dummy Distributor/Drive” that replaces the ignition distributor on an engine. FIG. 14B is the sensor on the top and is driven by the oil pump driveshaft/Timing gear “Dummy Journal”.

### REFERENCE NUMERALS

| | | | |
|---|---|---|---|
| 220 | Upper spindle | 222 | Upper Magnet Face |
| 320 | Lower Magnet spindle | 322 | Lower Magnet Face |
| 420 | Threaded | 422 | Hole |
| 520 | Threaded | 920 | Hole or Slot |
| 922 | Journal Assembly | 924 | Bearing |
| 926 | Retainer | 928 | Timing Assembly |
| 930 | Timing Cover | 932 | Sensor |
| 1220 | Slots | 1224 | Slots |
| 1320 | Optic | 1420 | Driveshaft |
| 1424 | Sensor | | |

### DETAILED DESCRIPTION

### First Embodiment

### Magnets.

The lower magnet is located in the valve spring seat. The center bore diameter of the lower magnet is the outer diameter of the valve guide boss or slightly larger but has minimal clearance. As shown in FIG. 1 the valve keeper is between the upper and lower magnets. The lower magnets function is to pull the valve down. The magnets are constructed of magnetically soft metals (ex. Silicon-Iron). Coil wire wraps around the center spindle between the upper face and lower seat 320. The upper magnet (FIG. 2) is made of the same materials as the lower magnet. Copper wire wraps around the upper section of the spindle 220. Depending on the amount of wire a top “cap” may be required to hold the coiled wire on the upper magnets spindle. The active face of the magnet is directed toward the valve keeper 222. The upper magnet rests in the valve cover that has corresponding recessions to retain, seat, and orient the upper magnet in relation to the angle and specific placement of the valve and valve keeper (as shown in FIG. 1.) The upper magnet operation is to hold the valve closed (up position) until it is necessary to move the valve and valve keeper assembly down.

### Valve and Valve Keeper

The Valves are constructed of Titanium or Stainless steel. Titanium and Stainless Steel are used in engines currently for valve metal and these are both metals that are magnetically soft with different permeability than that of Silicon-Iron. The valve length is shorter than traditional valves (Traditional being valve spring retained) and has threaded retention sections at the top of the valve stem 520. The Threaded Valve keeper (FIG. 4) is made of materials that are attracted by magnetic force (example—laminated sheet iron). It has holes drilled in the material to reduce weight 422. The holes reduce Eddy currents caused by magnetic fields. The center bore of the valve keeper is threaded to match the valve stem 420. The thread pitch is chosen to withstand the forces from accelerating the mass of the valve and keeper. Thread locking adhesive is applied to the threads before the keeper is installed. The valve can be hollow if it doesn't affect the acceleration forces negatively or makes the valve weak. These materials are currently in use for production car valves, they are magnetically soft metals, and have permeability that allows the valve to work with the magnetic forces proposed in this invention. Installation of the valve and valve keeper in the cylinder head are as listed: Install the valve into the cylinder head inserting the threaded valve stem into the valve guide from the combustion chamber side of the cylinder head, push the valve into the guide until the valve seats in the combustion chamber seat. On the valve cover side of the cylinder head the threaded section of the valve steam protrudes from the valve guide, place some of the threaded valve keeper thread locker onto the threads of the valve stem and the valve keeper, install the lower magnet, and spin the valve keeper onto the valve stem 520. Ensure the valve does not bind in the keeper. The wiring for the lower magnets is placed in the appropriate retainer clip for later wiring harness install.

### Top Dead Center Indicator

The Top Dead Center Indicator (TDCI) FIG. 9 and FIG. 14, indicate where Top Dead Center (TDC) cylinder #1 is. The camshaft mechanically sets where TDC #1 is with relation to the valves. This mechanical constant ensures timing does not change when the battery is changed or engine is shut off. That concept is replaced by the TDCI. The TDCI is a pickup sensor that detects the signal from the mechanically driven timing set FIG. 9A or dummy drive FIG. 14 A/B. For example a cam in block engine with the cam directly above the crankshaft (Ex. Small and Big block Chevrolet, Ford, Chrysler, LS1 Chevrolets, etc.) all have timing sets in this location. Using a “Dummy Journal” 922 and a dummy journal retainer plate 926, the upper cam gear bolts to the dummy journal in the same mannerism it did with the camshaft, but the end result is no camshaft. The timing cover is modified with a cast or welded in sensor mount. The sensor 932 is placed directly over the hole in the upper Timing gear 920 to indicate to the VCM where TDC #1 is. The VCM takes the input and resets the counter for #1 cylinder at initial start up. The initial start up is the main function of the TDCI, but the processor and software compare where the count is to where the TDC is indicated (relative to the count). Any discrepancy and the VCM send problem codes to the ECM. The design for older engines replaces their distributor with a “Dummy drive” FIG. 14 that fills the hole in the block where the distributor goes, retains the drive mechanism 1420 that operates the oil pump, but has a sensor 1422 on the top to indicate where TDC #1 is. The reason this would be used on some engines (ex. Ford small block V8) the front timing cover is integral to the water pump housing. A sensor is not mountable in the timing cover. The oil pump is driven by the distributor drive shaft. Other types of engines (ex. Air-cooled Porsche/VW) have a design that does not have a timing cover and the dummy drive allows the electromagnet system to work with these engines. The TDCI can be adapted to engines that have timing belts, Overhead camshafts, Timing chains, or Timing gears.

### Valve Control Module

The Valve Control Module (VCM) FIG. 6 A/B is a processor-based controller that receives inputs and delivers outputs at specific times, voltages, and amperages. The simpler VCM is a controller that has a single profile loaded into the firmware for control of the valves. The firmware has a specific count number to look for and does not vary the count number. A more complex VCM that has a larger processor, more inputs/outputs, and is loaded with more firmware for valve control is used for the fully variable valve profile engines. The firmware includes multiple valve control maps that are selectable. Silicon Controlled Rectifiers (SCRs) receive an input signal voltage that allows more or less voltage and amperage to flow through them. The VCM provides the input signal and the main fuse box provides the larger current to the SCRs and magnets. The varied signal is identified as pulse width and is calculated and expressed as duty cycle percentages. The VCM varies the signal based on the firmware interpretation of engine demands received as signals from Throttle position sensor (TPS), Crankshaft trigger wheel (CTW—this provides the count), Oxygen sensor (O2 sensor), and Engine Knock Detection sensor (KDS). These sensors are commonly used for ECM control of the fuel injection system on modern cars. The VCM has one SCR per valve function. This means one SCR to control the up function of the intake or exhaust valve group and one SCR to control the down function of the intake or exhaust valve group. Two SCR's per valve, one SCR to control the upper magnet(s) and one SCR to control the lower magnet(s). Sizing the SCR is based on the required voltage and amperage to move the valve(s) at the specified acceleration and distance relative to the input voltage and amperage and how many magnets each SCR controls. The SCR is bigger for more valves; higher valve lifts, and longer valve durations. Engine demands increase the size of the SCR. The VCM can house a voltage booster. A voltage booster may be necessary for speed of valve actuation through magnetic field generation. Increasing the voltage through the wrapped conductor causes the magnet to develop a magnetic field faster thereby increasing the RPM range of the engine. The VCM can also be separated into two sections, the high side and the low side. The high side contains all the high amperage electronics that energize the magnets and the low side is the processor controller. They are separate to reduce electronic noise.

### The Crankshaft Trigger Wheel

The Crankshaft trigger wheel has 180 windows FIG. 12A for most applications. As the control of the duration and opening/closing of the valves needs to be more precise, a trigger wheel with 360 windows FIG. 12B can be used. The number of windows used is relative to control of the valves. More windows means more control. The theory states an increased control of the valves as the crankshaft still spins 360 degrees two times to indicate a four-stroke cycle. A 360-window wheel gives ½ degree control for timing the valves. The counter in the VCM is adjusted to 1440 count for a four-stroke cycle. The trigger wheel design is 180 windows cut into the wheel (FIG. 12A is an example and only has a few example windows) and software programmed to count both the ups and downs of the trigger wheel optic sensor signal. FIG. 12B is the trigger wheel for the 720 count. This trigger wheel has offset windows and two optic sensors the software works for precise control of the valves. There is no specific indicator on the trigger wheel to indicate TDC #1 because the TDCI sends a signal to indicate TDC #1. This implies the only job the trigger wheel is to provide a count. The optic sensor and mount are shown in FIG. 13A/B. To determine the width of the windows and the diameter of the trigger wheel the equations for Circle Arc Length are used.

### Software and the Count

The software uses a count to control valve operation. The operation uses the firing order of the specific engine and a specific start count number for each cylinder. Examples of the firing order and specific “0” or start count positions are given in FIG. 8A. The firmware works with the 180-window wheel by counting both the window and the closed gap of the wheel. Software adjusts the opening and Patent closing of valves and can alter the valve profile overlap if the full variable software is loaded. The reason for valve overlap is the scavenging effect on the cylinder. The overlap can also be changed by the VCM to increase or decrease the amount so higher RPM's can benefit from the scavenging effect, but reduce the amount for emissions and smooth idle when the engine returns to lower RPM's. This is achieved through the valve map FIG. 10A changing the specific open and close count numbers for the variable software otherwise the open and close are fixed numbers. To establish when to operate the valves the software is loaded with either a set count number of when to operate a specific valve at a specific time or a variable count based on the FIG. 11 A/B/D equations and “Valve Maps” FIG. 10A. The valve map in FIG. 10A are used by the VCM processor to acquire specific count numbers to actuate specific valves. The equation in FIG. 11C is used to establish what valve profile is loaded into the software. FIG. 10A is an example valve chart using the listed equations. The software has two charts for each valve. One chart is to open the valve and one chart to close the valve. Another chart is a “Hot Key” chart. It is a single load function setup on a button in the interior of the vehicle. For example the button could be for “Tow-Haul” mode, “Sport” or “Race” mode. To increase the precision of the chart shown in FIG. 10A it can be expanded by TPS or RPM signals that are in smaller increments (example: as appose to 0.8 then 0.9 the chart has 0.81, 0.82, 0.83, etc. and for RPM 1.1, 1.2, 1.25, etc.). The size of the chart is based on memory and processing power of the VCM. The precision of the chart is decided by demands of vehicle performance. The software controls the signal voltage sent to the Silicon Controlled Rectifiers (SCR). An advantage of using SCRs is SCR's allow the transfer of larger amounts of voltage and amperage with small signal voltages. The upper magnets are “normally on” magnets that receive signal voltage, cycling up and down in specific ranges, creating and maintaining the magnet fields. To actuate the valve, signal voltage is sent to the lower magnet SCR and signal voltage is reduced to the upper magnet SCR reducing the upper magnet field strength. The magnetic field generated from the lower magnet is only strong enough to draw the valve and valve keeper down to a specific point. To calculate the magnetic requirements the mass of the valve, the acceleration of the valve, and the required distance need to be specified. The software has a specific “Save Last” function that provides the VCM what the position of the valves were when the engine stopped (key off).

### Equations

The equations are used to build the valve maps for the specific count number. The equations have placeholders Xx1 and Xx2, their functions are described below the equations. A valve profile is chosen based on the vehicle performance requirements. To establish what the total valve duration profile is the use of FIG. 11C is necessary. The equation in FIG. 11C has the constant 180 in the equation for the piston travel count. FIG. 11D is the modified equation for the 360-window trigger wheel.

### Oiling System

As engines have moved to the modern world the oil pump has moved its location and drive mechanism. In older engines the oil pump was cam or distributor driven, but this proves unreliable because the drive mechanism is known to break. The engines being produced now have the oil pump driven directly off the crankshaft eliminating the drive mechanism. To adapt this invention to some applications (ex. Ford OHV V8) a gear is added to the back of the dummy journal 922 to drive the oil pump driveshaft 1420 and dummy drive FIG. 14 A/B. Older engines that have oil pumps driven by the camshaft and no way to drive them after the adaption of this invention are changed to dry sump oiling. The engine design with distributor driven oil pumps is being phased out due to the oil pump being moved to the crankshaft by engine manufacturers. Certain engines (ex. Camshaft in block) have oil galleries that lubricate the camshaft, to block these off, the cam bearings are clocked 90 degrees to block the oil feed hole.

### Physics

The physics used to calculate magnetic flux relies on knowing: amperage and voltage of a circuit, number of windings on a magnet, resistance of the conductor, permeability of the magnet material, air gap between magnet and mover (threaded valve keeper), weight of the object being moved (valve+threaded valve keeper), the distance the object needs to move, and what acceleration it needs to move at. Calculating the lines of flux will place the threaded valve keeper relative to the listed information above. The magnets will create a “Magnetic Spring” effect. This effect is changing of the upper magnet field and changing of the lower magnet field to have controlled movement of the valve.

### Operation

The initial start up involves turning the ignition key to the on position sending 12v to the VCM controller, the VCM sends signal voltage to the TDCI before the engine has initial turn. The key is turned to the start position (or start button pushed) and the TDCI indicates it has found top dead center #1. The optic sensor begins signaling the count with on/off. The software counts both the on and offs to give a full 360 counts. The software sends signal voltage to the Silicon Controlled Rectifiers (SCR) for the specific valve to operate. The valve operation sequence is loaded into the software prior to installation of the VCM. The VCM monitors the engine speed by comparing the count from the trigger wheel and the TDCI signal. It loops the loaded valve operation sequence until the key is turned off. When the key is turned off the software saves the last position of the valve sequence to use when the key is turned back on. If battery voltage is lost after that point, the VCM starts over on the preloaded software to pick up the TDCI signal and start the valve operation sequence over.

### Advantages

From the descriptions above, a number of advantages of some embodiment of my Electromagnetic control of engine valves become evident.

(a) Materials for the invention are already in use.

(b) Requires no special machining to cylinder heads

(c) Eliminates the camshaft, lifters, pushrods, valve springs, and retainers.

(d) Simple installation requiring no special tools or labor

(e) Cylinder head port design no longer has to work around camshaft placement.

(f) The processor-based controller can have new valve profiles loaded into the software eliminating the need for camshaft replacement to change engine performance.

(g) Reduced specialty machining for engine production. The camshaft science involved with creating the desired operating power band can be programmed in and tested without new camshafts

(h) Intake and Exhaust port orientation can be reversed to optimize accessory (ex. Turbocharger) placement.

(i) Reduced cylinder head engine weight opens engines and cylinder heads for new materials of production.

(j) Increased engine operating revolutions per minute (RPM) range. With less internal rotating mass the engine will rev through its operating range faster.

(k) Engine “In Service”. The oils in the engine will lubricate fewer parts, thereby making the engine oil last longer (staying cleaner and cooler) facilitating better lubrication for the rest of the rotating parts. The end result is the engine will last longer. This is evident from the introduction of modern oils and engines lasting over 200,000 miles.

(l) Reduced engine rotating mass. Increasing the fuel efficiency through reduced internal friction and reduced engine weight.

### CONCLUSION, RAMIFICATIONS, AND SCOPE

In conclusion the reader sees that the electromagnetic control of engine valves can be implemented with this invention. Its simple easy to install design uses materials that are currently used for engine production. It doesn't require special Cylinder heads or elaborate mounting devices. Valve service is attainable without special tools or excessive labor. Through removal of the camshaft and valve train the engine is more efficient with reduced internal friction adding to the engine operation life and service intervals. Furthermore, the electromagnets have the additional advantages in that:
Allows the cylinder head design to be free of camshaft placement restrictions on port design, combustion chamber design, valve angles, drive mechanisms, port orientation, and construction materials.
Allows for loadable valve profiles to change engine performance.
Allows for a variable valve profiles that are processor controlled
Allows for reduced emissions from engines
Allows for reduced materials for production of engines
It provides service of engine wear parts and reduces the number of engine wear parts.
   The descriptions above contain many specific examples, but these should not limit the scope of embodiments, merely provide examples of several embodiments. As an example the valve keeper shape may change to accommodate more applications. The Top Dead Center Indicator (TDCI) will also change its configuration to adapt to specific engine designs other than those listed above. Thus the scope of embodiments should be determined by the application of the invention rather than by the examples given.

I claim:

1. A method for controlling engine valves on the vertical axis with the use of electromagnets, a keeper, and a controller.

2. Further including from claim 1 electromagnets replace the valve springs for retention and replace the camshaft for actuation.

3. Further including from claim 1 a valve keeper to convert magnetic force into valve movement.

4. Further including from claim 1 each valve has corresponding retention for the installation and removal of the valve keeper.

5. Further including from claim 1 non-magnetic covers to retain and place the upper magnet and wiring.

6. Further including from claim 1 non-magnetic covers to protect the valves from debris.

7. A method of controlling the electromagnets thereby controlling the valves.

8. Further including from claim 7 sensors to indicate to the controller piston and crankshaft position.

9. Further including from claim 7 equations for count numbers.

10. Further including from claim 7 means of interpreting control signals from inputs.

11. Further including from claim 7 means of communication with electromagnets thereby controlling valves.

12. A method of controlling electromagnets with a processor.

13. Further including from claim 12 means of transferring voltage and amperage with a processor signal.

14. Further including from claim 12 means of voltage and amperage boosting through inductance.

15. Further including from claim 12 means of communication with external devices.
